(19) United States
(12) Patent Application Publication
(10) Pub. No.: US 2020/0074818 A1
(43) Pub. Date: Mar. 5, 2020

(54) SONIFICATION SYSTEM AND METHOD FOR PROVIDING CONTINUOUS MONITORING OF COMPLEX DATA METRICS

(71) Applicant: The United States of America, as represented by the Secretary of the Navy, San Diego, CA (US)

(72) Inventors: Matthew Galligan, Delran, NJ (US); Nhan Nguyen, Huntingdon Valley, PA (US)

(21) Appl. No.: 16/115,745

(22) Filed: Aug. 29, 2018

(51) Int. Cl. G08B 3/10; G10H 1/00; H04L 12/26

(52) U.S. Cl. CPC G08B 3/10; G10H 2210/111; H04L 43/08; G10H 1/0025

(57) ABSTRACT

A sonification system and method for providing continuous monitoring of complex data metrics, such as that from computer system activity, by taking data from multiple streams and reducing each stream of data into an easily understood audio signal that is easily distinguishable from other audio signals generated from other data streams. The sonification system and method operates to map multi-dimensional data graphs to audio and consists largely of silence, separated by terse and informative audio signals which each provide information related to intensity measurements and quantity measurements during a predetermined time interval.

### STATEMENT OF GOVERNMENT INTEREST FEDERALLY SPONSORED RESEARCH AND DEVELOPMENT

The United States Government has ownership rights in the subject matter of the present disclosure. Licensing inquiries may be directed to Office of Research and Technical Applications, Space and Naval Warfare Systems Center, Pacific, Code 72120, San Diego, Calif. 92152; telephone (619) 553-5118; email: ssc_pac_t2@navy.mil. Reference Navy Case 103688.

### BACKGROUND

This disclosure relates generally to a system for mapping a plurality of streams of data into audible signals in order to enable continuous monitoring of each of the streams of data through an audio interface.

Continuous monitoring of data such as that of computer system activity is often conveyed by a visual log or graph and can be visually dense and require significant attention to be use. Moreover such displays of logs or graphs can also consume significant space on a user's graphical user interface and compete for attention with other tasks which may be desired to be performed. Additionally, depending on what other tasks are being performed at a given moment, such displays may not remain on screen or visible at the necessary times.

Audio monitoring of various types of activity has been used historically, but it often has relied on strictly alarm driven behavior (for example, only acting upon the occurrence of a predetermined pattern detected by the applicable software and/or computer system) or has provided an output that is ambiguous in the presentation of information by using a large number of variations in acoustic parameters. For example, not all users may be able to distinguish between specific musical notes (e.g., the same musical note played at different octaves), especially without a reference note. In other existing applications, the actual audible signal being produced may not meaningfully relate what is being monitored to the activity that is occurring.

Moreover, in many existing applications in which monitoring is attempted through an audio interface, a user is often inundated with more data (i.e., audible signals) than is required, which in itself could be fatiguing to a similar extent to monitoring through a visual interface.

Thus, there remains a need for a sonification system for providing continuous monitoring of complex data metrics, such as computer system activity, that requires less attention that traditional monitoring methods and limits the production of superfluous audio signals.

### SUMMARY

The present disclosure describes a sonification system and method for providing continuous monitoring of complex data metrics. In accordance with an embodiment of the present disclosure, the sonification method for providing continuous monitoring of complex data metrics begins with the step of receiving, by at least one computer system, a stream of data packets, wherein each of said data packets includes a plurality of activity related measurements. Upon the expiration of a predetermined time interval, the method includes producing a separate aggregate stream value for each of the plurality of activity related measurements. The method further includes reducing the aggregate stream values to an audio sequence having at least one audio selection that includes a plurality of audio parameters, wherein the step of reducing includes mapping at least one of the aggregate stream values to one of the plurality of audio parameters of the at least one audio selection so as to establish an audible relationship between the aggregate stream values and one of the plurality of audio parameters; and playing by at least one computer system the audio sequence on an audio output interface.

### BRIEF DESCRIPTION OF THE DRAWINGS

FIG. 1 is a block diagram showing the electrical and audio signal flow of a sonification system in accordance with the present disclosure.

FIG. 2 shows the steps of a sonification method in accordance with the present disclosure.

FIG. 3 shows an example of a graphical user interface window for defining a Channel in a sonification method in accordance with the present disclosure.

FIG. 4 shows an example of a mapping protocol for reducing Data Packet values to a Sequence in a sonification method in accordance with the present disclosure.

FIG. 5 shows an example of a workstation/server monitoring implementation of a sonification method in accordance with the present disclosure.

FIG. 6 shows an example of a continuous network monitoring implementation of a sonification method in accordance with the present disclosure.

### DETAILED DESCRIPTION OF VARIOUS EMBODIMENTS

Described herein is a sonification system and method for providing continuous monitoring of complex data metrics that (1) maps multi-dimensional data graphs to audio in a clear and understandable manner, (2) consists largely of silence, separated by terse and informative signals, (3) provides a high degree of interpretation confidence by dramatically reducing/simplifying output signals, and (4) handles multiple streams of data, each of which can be easily distinguishable from the end user. Applicant's sonification system and method operate to take data from multiple streams of data (which, depending on the application, could include file activity, network activity, land speed and direction, or other such multi dimensional graphs) and reduce each stream of data into an easily understood audio signal that is easily distinguishable from other audio signals generated from other data streams so as to provide a high level of confidence in data interpretation.

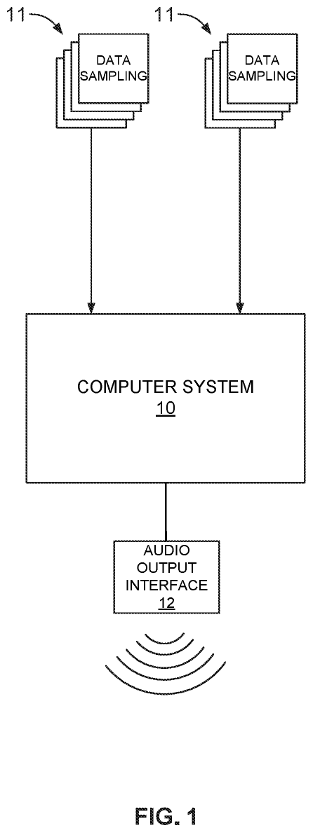

Referring now to the drawings, and in particular, FIG. 1, Applicant's sonification system includes a computer system 10 which can access instructions embodied in software which enable the computer system 10 to perform the sonification steps of configuring of a monitoring program, collecting discrete streams of data samplings 11 that contain at least a value for both Intensity and Quantity, producing aggregate values for the individual samplings of data, reducing the aggregate values into a Sequence, and causing the Sequence to be played on an audio output interface 12 as described below. It is contemplated that such a computer system 10 may define a computer that includes one or more processors and is embodied as a single workstation, a collection of workstations, or even a server and/or a collection of servers.

In the description that follows, a number of terms are used and the following definitions are provided for the terms, when specifically used with capitalization, in order to facilitate understanding of the disclosure herein. Terms that are not explicitly defined are used according to their plain and ordinary meaning.

A Data Packet is an individual sampling of data that contains at least a value for both Intensity and Quantity. This is usually an instantaneous reading.

Intensity is one of two values associated with a Data Packet. Intensity is an activity related measurement that describes the total load, work done, or volume of what is being measured (e.g., CPU Load, File IO Throughput, and power output).

Quantity is one of two values associated with a Data Packet. Quantity is an activity related measurement that describes the number of operations or impulses of what is being measured (e.g., Processes running, File operations, RPM, and Network packets processed).

A Sample is an audio clip representing a particular Instrument played at particular musical note.

An Instrument refers to the sound of a particular Sample, usually represented by a particular real-world musical instrument such as a piano, pan flute, violin. An Instrument as defined in the present disclosure will generally represent and correspond to a particular Channel and will contain enough individual Samples being played at different musical notes to play all possible outputs that may be generated for Channel in accordance with the present disclosure.

A Channel contains a Data Packet stream and a description of the Channel. All received Data Packets are periodically processed so as to generate a single Sequence for a Time Slice. A Channel has upper and lower limits defined for Intensity and Quantity, and optionally contains Threshold values for Intensity and/or Quantity.

A Sequence is the audio output for a set of Data Packets. A single Sequence represents a series of Data Packets collected over a Time Slice. A Sequence is comprised of a single Reference Tone and a set of Data Tones that describe the set of Data Packets.

A Reference Tone is an audio portion played at the start of a Sequence, to allow the listener to more easily distinguish the notes of the Data Tones that follow.

Data Tones refers to an audio selection defined by a set of one or more Samples that are played after the Reference Tone to represent to the user the Intensity and Quantity of a set of Data Packets in a particular Channel. For a given selection of Data Tones, the note of the Sample(s) is dependent on the Intensity, the Quantity value dictates how many times the Sample will be repeated and the Instrument for the Sample(s) is dependent on the particular Channel of the Data Packet set.

A Time Slice is the interval at which a stream of Data Packets in a given Channel is processed and a Sequence for that given Channel is produced.

A Step Value is the total number of distinct musical notes available for an Instrument for describing the (generally small) range of output values (which as described above, may be the Intensity value. Generally this number is small to provide the highest confidence in user recognition and simplest output. For the rest of this disclosure, a Step Value of 3 (High, Medium, Low) will be used as an example to describe operation. This value is recommended, but the operation of the present disclosure is not limited to a particular Step Value.

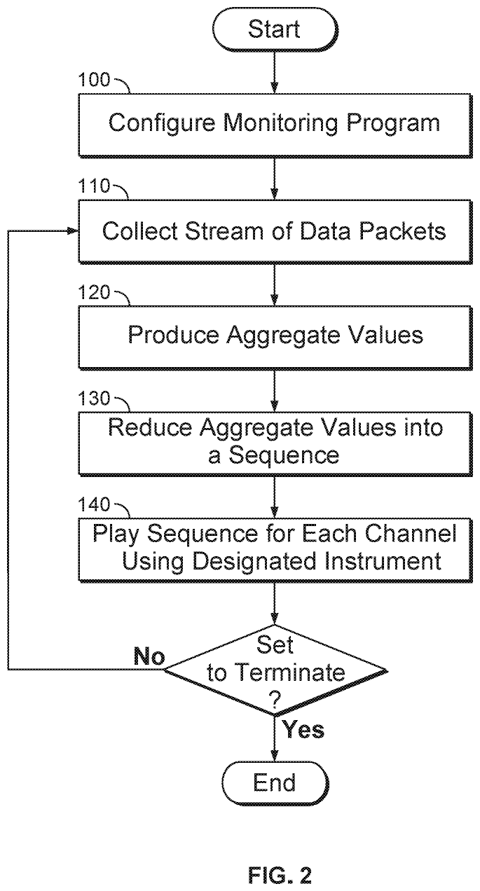

Referring now to FIGS. 2-6, a sonification method for providing continuous monitoring of complex data metrics begins with the configuration of a monitoring program on the computer system 10 at step 100. The configuration of a monitoring program includes designating a series of Samples to be played after a Reference Tone to represent both Intensity and Quantity to the user. The note may be dependent on the Intensity, and the Quantity value may dictate how many times the note will be repeated.

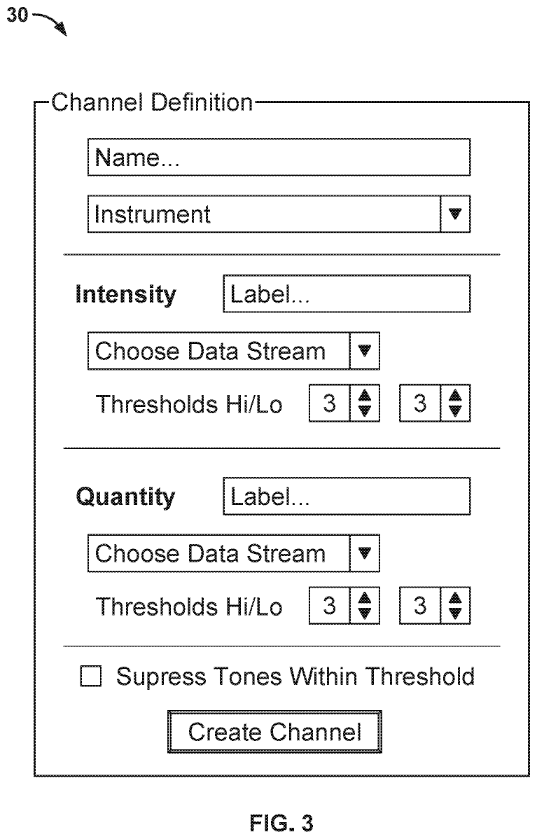

The configuration of a monitoring program also includes defining one or more Channels through a graphical user interface window 30 as illustrated in FIG. 3, specifying descriptive labels to the available fields as desired.

The configuration of a monitoring program also includes defining the maximum Time Slice, which both indicates the interval at which output is produced, and how many Channels may be supported at one time. It is contemplated that this may also be done through the graphical user interface window 30.

Once configured, the sonification method begins receiving and collecting a stream of Data Packets at step 110 via methods such as network collection, external sensors, process output, and so forth. It is appreciated that these Data Packets may contain at least Intensity and Quantity values, with the specific value varying depending on what operation the Data Packets reflect.

Then, at each Time Slice interval, and for each Channel, the sonification method produces an aggregate value for Intensity and an aggregate value for Quantity at step 120. It is contemplated that these aggregate values, which may be referred to as aggregate stream values, can be set to reflect an average-over-time value, high values, low values, and so forth during the configuration step.

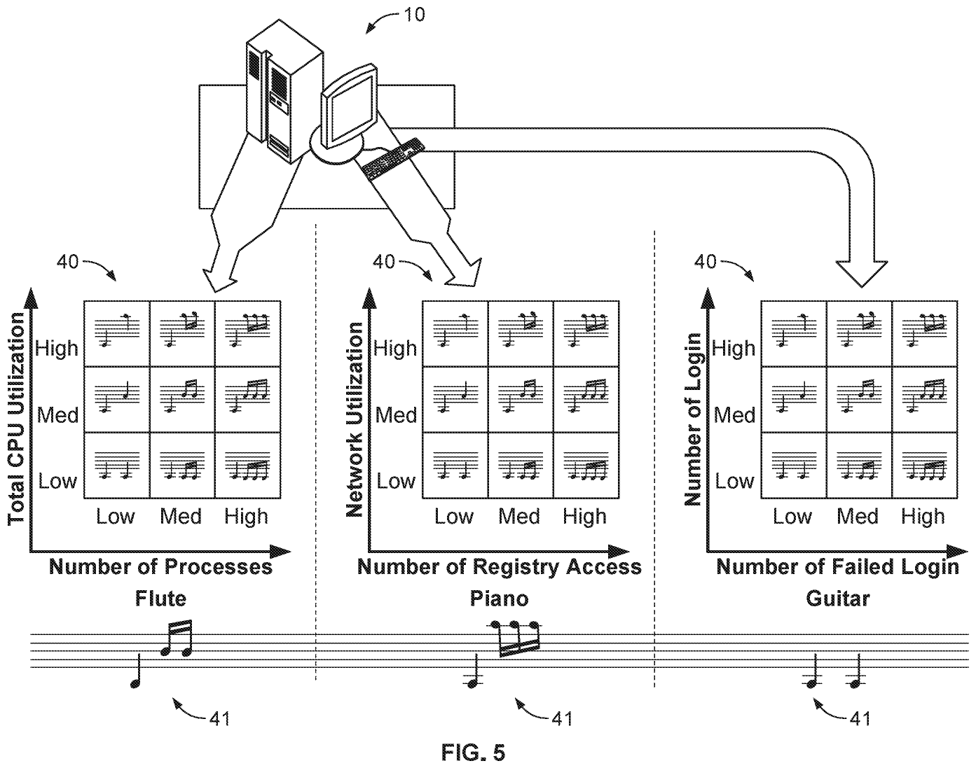

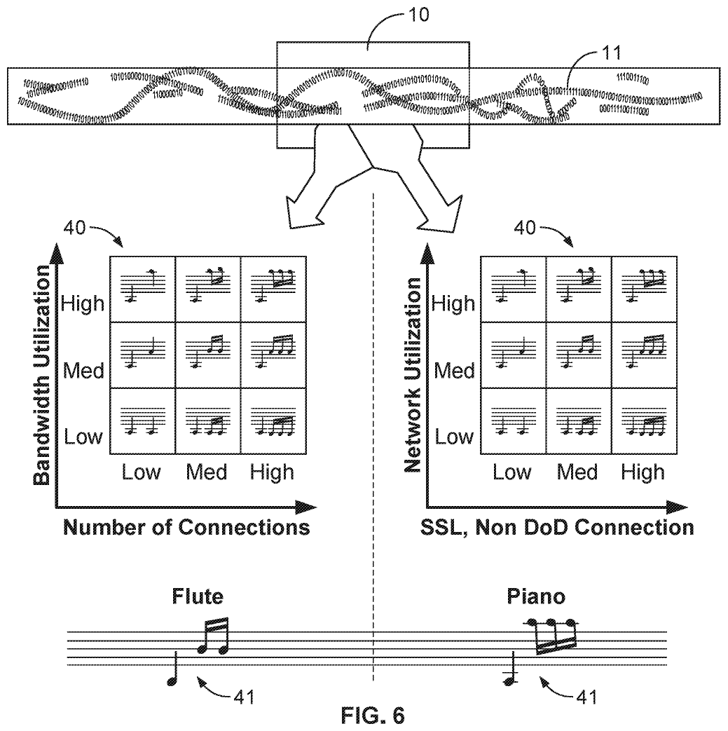

When a Channel is set to monitor one stream of Data Packets (by selecting the same Data Stream on for both Intensity and Quantity when defining the relevant Channel), the Channel may be set to retrieve the Intensity value and the Quantity value of the stream of Data Packets. As an alternative option, when monitoring multiple systems, because a single Channel may be set to retrieve the Intensity value of a first stream of Data Packets and the Quantity value of a second stream of Data Packets, streams of Data Packets may be aggregated over multiple systems on a single Channel, producing one set of Intensity and Quantity values with the Intensity value of a first system and the Quantity value of a second system, as illustrated in FIGS. 5 and 6. This can allow a user to monitor many data points at once with a single Sequence per Time Slice.

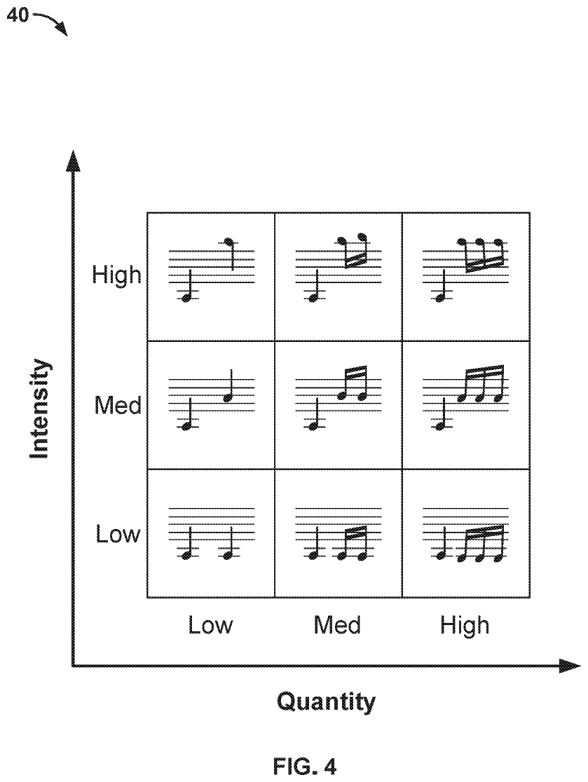

Once the aggregate value for Intensity and for Quantity are produced for each Channel, the sonification method reduces these values into a Sequence at step 130. An example of such mapping 40 from Data Packet values to a set of Data Tones is shown in FIG. 4. This shows how Intensity and Quantity values are corresponded to a musical note(s) and a number of repetitions.

As exemplified in FIG. 4, the Data Packet values are reduced to a low-resolution audio representation with a small collection (represented by Step Value) of notes selected to be easily distinguishable. For example, in the illustrated example, the following notes are used to show Intensity:
A5: High (Top ⅓ of possible values) Intensity;
A4: Medium (Middle ⅓ of possible values) Intensity; and
A3: Low (Lowest ⅓ of possible values) Intensity.

Additionally, the audio representation will be played one or more times, as indicated by Step Value. As illustrated in FIG. 4, which uses a Step Value of 3, the following repetition patterns are used to show Quantity:
3 Repetitions: High Quantity (Top ⅓ of possible values);
2 Repetitions: Medium Quantity (Middle ⅓ of possible values); and
1 Repetition: Low Quantity (Lowest ⅓ of possible values).

Once the Data Packet values are reduced to a set note and repetition, an audio output selection 41 that will be used for Data Tones is produced. But before the Data Tones are played, a Reference Tone is added to assist the listener in identifying the correct tone. The Reference Tone provides the user with a frame of reference to compare the Data Tones and also emphasizes the difference between “normal” and the current output. The Reference Tone and Data Tones together form the Sequence.

Once a Sequence is computed for each Channel, the sonification method then plays for each Channel the computed Sequence using the Instrument associated with the Channel via an audio output interface 12 at step 140. It is contemplated that the audio output interface 12 may define a speaker. Typically, a different Instrument is assigned to each Channel to easily differentiate the data being reflected. For example, piano tones may be used to indicate network activity, while flute tones may indicate registry accesses. A small delay may be introduced in between each Sequence.

While playing the Sequence for each Channel, and after playing the Sequence for each Channel, the sonification method continues to collect Data Packets for each Channel, essentially returning to the step 110. The sonification method will wait for the duration indicated in the Time Slice before proceeding through steps 120, 130, and 140. It is contemplated that this process may continue until terminated or cancelled by a user.

Referring now to FIG. 5, in an example of a workstation/server monitoring implementation of the sonification system and method, a system administrator has set up a long-polling audio monitoring of a particular system of interest. Every 15 minutes (the Time Slice as defined by the administrator), the following 3 Channels will play:
Processor Montioring: CPU Utilization and Number of Process;
Network Utilization and Registry Access (to correlate these two factors); and
Number of Login Attempts and Failed Login Attempts.

Referring now to FIG. 6, in an example of a continuous network monitoring implementation of the sonification system and method, a network administrator that wishes to observe network traffic on a regular basis may employ the following Channels:
Total bandwidth utilization and Number of connections (to identify the balance between users and load); and
Total network utilization and Non-Internal DoD connections (to identify the amount of network traffic that involves external hosts).

In both of these situations, a “bad” or alarm state is not necessarily known in advance. Similarly, a “bad” or alarm state is unlikely to be able to be detected through traditional software algorithms. Through continuous and low-effort audio monitoring, however, a human user can provide insight into data patterns and listen for abnormal patterns while performing other visually-intensive tasks.

It is contemplated that the present disclosure may provide for greatly improved recognition of audio samples due to significantly increased degree of acoustic orthogonality.

It is additionally contemplated that the present disclosure may provide for dramatically reduced time and attention requirements due to both short sample length, long periods of silence, and generally non-jarring tones.

Moreover, through its reliance on human pattern recognition as opposed to pre-programmed patterns for monitoring complex systems, the present disclosure allows a listener to discover new patterns instead of just matching pre-defined patterns.

It is further contemplated that the present disclosure may provide for the ability to encode multiple dimensions of data into simple audio output, unlike many existing applications which map a single value to a particular Sequence and still may fall short of the terseness of the method described herein.

It is appreciated that the present disclosure may provide for continuous and low-effort audio monitoring and allow insight into data patterns to be obtained while other visually-intensive tasks are performed.

It is additionally appreciated that additional data values for Data Packet beyond Intensity and Quantity, such as amplitude, time compression, or signal modulation, may be measured and expressed with other audio characteristics beyond note and repetition.

Furthermore, although musical notes are specified in the examples above, the system and method described herein is not limited to such musical samples and can be used with any sort of sound clip.

In addition, in situations involving multiple different scanning requirements, a different Time Slice value could be used for different Channels, such that certain data was reported back more frequently than others.

Moreover, although the examples above largely refer to information system monitoring, it is contemplated that this sort of simple-to-understand audio rendering could potentially have application in areas such as vehicles or weapon systems.

It will be understood that many additional changes in the details, materials, steps and arrangement of parts, which have been herein described and illustrated to explain the nature of the disclosure, may be made by those skilled in the art within the principle and scope of the disclosure as expressed in the appended claims.

What is claimed is:

1. A sonification method for providing continuous monitoring of complex data metrics, comprising the steps of:
receiving by at least one computer system a stream of data packets, wherein each of said data packets includes a plurality of activity related measurements;
upon the expiration of a predetermined time interval, producing a separate aggregate stream value for each of the plurality of activity related measurements;
reducing the aggregate stream values to an audio sequence having at least one audio selection that includes a plurality of audio parameters, wherein the step of reducing includes mapping at least one of the aggregate stream values to one of the plurality of audio parameters of the at least one audio selection so as to establish an audible relationship between the aggregate stream values and one of the plurality of audio parameters; and
playing by at least one computer system the audio sequence on an audio output interface.

2. The sonification method of claim 1, wherein the step of reducing additionally includes adding a reference audio portion to the audio sequence that is unaffected by the plurality of audio parameters of the at least one audio selection.

3. The sonification method of claim 1, wherein the plurality of activity related measurements include at least an Intensity measurement and a Quantity measurement.

4. The sonification method of claim 3, wherein the audio parameters include at least one of a musical note and a repetition pattern.

5. The sonification method of claim 4, wherein mapping at least one of the aggregate stream values to one of the plurality of audio parameters of the at least one audio selection includes mapping the aggregate stream value produced for the Intensity measurement to either the musical note or the repetition pattern and mapping the aggregate stream value produced for the Quantity measurement to either the musical note or the repetition pattern.

6. A sonification method for providing continuous monitoring of complex data metrics, comprising the steps of:
receiving by at least one computer system a plurality of discrete streams of data packets, wherein each of said plurality of discrete streams of data packets includes at least one activity related measurement;
upon the expiration of a predetermined time interval, producing a separate aggregate stream value for the at least one activity related measurement for the plurality of discrete streams of data packets;
reducing the aggregate stream values to an audio sequence having at least one audio selection that includes a plurality of audio parameters, wherein the step of reducing includes mapping at least one of the aggregate stream values to one of the plurality of audio parameters of the at least one audio selection so as to establish an audible relationship between at least one of the aggregate stream values and one of the plurality of audio parameters; and
playing by at least one computer system the audio sequences on an audio output interface.

7. The sonification method of claim 6, additionally comprising the step of configuring a monitoring program, wherein the step of configuring includes associating each of the plurality of discrete streams of data packets with at least one sound clip.

8. The sonification method of claim 7, wherein for each of the respective discrete stream of data packets in the plurality of discrete streams of data packets, the audio sequence is played by at least one computer system on the audio output interface using the at least one sound clip associated with the respective discrete stream of data packets.

9. The sonification method of claim 7, wherein each at least one sound clip is defined by a sound from a different musical instrument.

10. The sonification method of claim 6, wherein the step of reducing additionally includes adding a reference audio portion to the audio sequence that is unaffected by the plurality of audio parameters of the at least one audio selection.

11. The sonification method of claim 6, wherein the plurality of activity related measurements include at least an intensity measurement and a quantity measurement.

12. The sonification method of claim 11, wherein the audio parameters include at least one of a musical note and a repetition pattern.

13. The sonification method of claim 12, wherein mapping at least one of the aggregate stream values to one of the plurality of audio parameters of the at least one audio selection includes mapping the aggregate stream value produced for the intensity measurement of a first discrete stream of data packets in the plurality of discrete streams of data packets to either the musical note or the repetition pattern and mapping the aggregate stream value produced for the quantity measurement of a second discrete stream of data packets in the plurality of discrete streams of data packets to either the musical note or the repetition pattern.

14. A sonification system for enabling continuous monitoring of complex data metrics, comprising:
at least one computer system having at least one processor and access to instructions embodied in software which configure the computer system to at least receive a plurality of discrete streams of data packets and play at least one audio sequence on an audio output interface;
wherein each of said plurality of discrete streams of data packets includes a plurality of activity related measurements;
wherein upon the expiration of a predetermined time interval, the computer system is configured to cause a separate aggregate stream value for each of the plurality of activity related measurements to be produced;
wherein the computer system is configured to cause the aggregate stream values to be reduced to the at least one audio sequence, wherein the at least one audio sequence includes at least one audio selection that includes a plurality of audio parameters; and
wherein the reduction of aggregate stream values to the at least one audio sequence includes mapping at least one of the aggregate stream values to one of the plurality of audio parameters of the at least one audio selection so as to establish an audible relationship between at least one of the aggregate stream values and one of the plurality of audio parameters.

15. The sonification system of claim 14, wherein the computer system is additionally configured to configure a monitoring program which includes associating each of the plurality of discrete streams of data packets with at least one sound clip.

16. The sonification system of claim 15, wherein for each of the respective discrete streams of data packets in the plurality of discrete streams of data packets, the audio sequence is played by at least one computer system on the audio output interface using the at least one sound clip associated with the respective discrete stream of data packets.

17. The sonification system of claim 14, wherein the reduction of aggregate stream values to the at least one audio sequence includes adding a reference audio portion to the audio sequence that is unaffected by the plurality of audio parameters of the at least one audio selection.

18. The sonification system of claim 14, wherein the plurality of activity related measurements include at least an intensity measurement and a quantity measurement.

19. The sonification system of claim 18, wherein the audio parameters include at least one of a musical note and a repetition pattern.

20. The sonification system of claim 19, wherein the mapping of at least one of the aggregate stream values to one of the plurality of audio parameters of the at least one audio selection includes mapping the aggregate stream value produced for the intensity measurement of a first discrete stream of data packets in the plurality of discrete streams of data packets to either the musical note or the repetition pattern and mapping the aggregate stream value produced for the quantity measurement of a second discrete stream of data packets in the plurality of discrete streams of data packets to either the musical note or the repetition pattern.
